(19) United States
(12) Patent Application Publication
(10) Pub. No.: US 2003/0052101 A1
(43) Pub. Date: Mar. 20, 2003

(54) Method for cleaning debris off UV laser ablated polymer, method for producing a polymer nozzle member using the same and nozzle member produced thereby

(76) Inventors: Jianhui Gu, Singapore (SG); Puay Khim Lim, Singapore (SG); Pean Lim, Singapore (SG)

Correspondence Address: HEWLETT-PACKARD COMPANY, Intellectual Property Administration, P.O. Box 272400, Fort Collins, CO, 80527-2400, US

(21) Appl. No.: 09/952,918

(22) Filed: Sep. 14, 2001

(51) Int. Cl. B23K 26/00; B23K 26/14; B23K 26/16; B23K 26/18

(52) U.S. Cl. 219/121.71; 219/121.69

(57) ABSTRACT

A method of cleaning a polymer surface of debris deposited on the polymer surface as a result of laser ablation of the polymer surface using a UV laser beam is disclosed. Cleaning is carried out by irradiating the polymer surface using a Nd:YAG laser beam of a predetermined fluence. A method for manufacturing a polymer nozzle member of an inkjet printhead where the above cleaning method is used to clean a polymer film after the polymer film has been UV laser ablated to form orifices therethrough is also disclosed. A nozzle member that is manufactured according to the manufacturing method is also disclosed.

### BACKGROUND

This invention relates generally to a method for removing debris from a laser ablated polymer surface and a method for producing a polymer nozzle member for an inkjet printhead. More particularly, this invention relates to a method for cleaning a laser ablated polymer nozzle member to remove debris, namely carbon particles, produced by laser ablation without causing substantial physical change to the polymer nozzle member.

A prior art process of manufacturing nozzle members of inkjet printheads is disclosed in U.S. Pat. No. 5,305,015. The prior art process includes a step of laser ablating holes or orifices through a polymer film. During laser ablation of the polymer film, debris including carbon particles are deposited on the laser ablated side around the orifices. The debris if not removed will affect proper attachment of a nozzle member to a barrier layer in a subsequent manufacturing process. In use, the debris will affect refilling of a vaporization chamber defined partially by the nozzle member. Additionally, the debris may affect the trajectory of ejected ink drops through the orifices to degrade printing quality. A process known as plasma ashing is typically carried out in a plasma ashing chamber to remove the debris. In the plasma ashing chamber, electrical charges are generated to produce ozone for reacting with carbon in the debris to turn the carbon into carbon monoxide and carbon dioxide gases.

Though effective, plasma ashing suffers from several disadvantages. Plasma ashing requires a relatively long cleaning time—each cleaning cycle takes several minutes. Plasma ashing also requires an expensive low-vacuum environment. Additionally, the thermal effect as a result of the electrical charges dehydrates the polymer film to cause shrinkage of the polymer film, especially thinner polymer films.

In order for accurate orifice measurements to be taken from a dehydrated polymer nozzle member, the nozzle member is allowed to re-hydrate to as close to its original state. Such re-hydration takes as long as a few hours. While a sample of the nozzle member is taken off a production line to re hydrate, production of nozzle members is usually allowed to continue in the production line. There is a possibility that the sample is subsequently determined to be out of tolerance and rendered useless. The other nozzle members that are produced during the re-hydration period of the sample may suffer the same fate, causing wastage in both material and effort.

There are several conventional methods for removing debris from a surface that may be used as an alternative to plasma ashing. These methods include ultrasonic cleaning, megasonic cleaning, wiping and scrubbing, high-pressure jet spraying, etching etc. These methods variously suffer disadvantages that include ineffectiveness for cleaning micron and sub-micron particles, introduction of other contaminants and causing damage to a surface to be cleaned.

Removing debris or contaminants from a surface by irradiating contaminated areas with a laser beam is also known. However, it is not a simple task to select a laser that is effective in removing micron or sub-micron particles, such as carbon particles, from a polymer surface. If not carefully selected, laser cleaning may induce melting and/or annealing at the surface to introduce point defects and/or other surface irregularities. Laser cleaning may also permit some impurities to diffuse into the surface at the same time others are removed.

A pulsed CO₂ laser has been experimented with for removing debris from an excimer laser ablated polyimide surface. The result obtained is published in an article “CO₂ laser cleaning of black deposits formed during the excimer laser etching of polyimide in air” by G. Koren and J. J. Donelon, in the journal Appl. Phys. B. 456: 147-145-4649 (1988). An excimer laser at a wavelength of 308 nm with a fluence of 800 mJ/cm² is used to ablate a 75 μm thick Kapton™ polyimide film. A transversely excited atmospheric pressure (TEA) CO₂ laser at a wavelength of 10.6 μm with a fluence of 1700 mJ/cm². and a pulse duration of 1 μs is used to clean debris resulting from the laser ablation. Although effective to a certain extent, the polyimide surface demonstrates a high absorption of the CO₂ laser resulting in thermal effect or damage to the polyimide surface. The relatively long pulse duration of the TEA CO₂ laser also induces additional heat at the cleaned areas of the polyimide surface. Residual particles are also found to be formed at the cleaned areas.

A tunable TEA CO₂ laser for cleaning CO₂-laser-drilled vias of a diameter of about 220 μm in a polyimide-based flex circuit is disclosed in an article “Laser cleaning of ablation debris from CO₂-laser etched vias in polyimide” by K. Coupland, P. R. Herman, and B. Gu, published in the journal Appl. Surf. Sci., 127-129: 731-737 (1998). The laser drilling causes debris, both massive (>10 μm) fibrous debris and sub-micron (<500 nm) soot, to be deposited on the surface of the flex circuit. The characteristics of such debris are a result of the interaction of the long-wavelength laser beam with polyimide. The debris retained most of the original polyimide structure. Cleaning using the tunable TEA CO₂ laser removed large massive fibrous debris. However, it is noticed that such cleaning generated surface ripple and damaged the cleaned area. Additional small particles (<100 nm) are also found to be re-deposited adjacent the cleaned region.

Excimer-laser-generated debris is different from that discussed above. Eximer-laser-generated debris includes highly decomposed, carbon-rich soot. It is also known that excimer lasers are not suitable for cleaning a polyimide surface. At ultra-violet (UV) wavelengths, an excimer laser beam has photon energies that exceed the molecular bond energy (3-5 eV) of polyimide. UV excimer lasers are therefore suitable for ablating but not cleaning a polyimide surface. Polyimide also has a very high absorption coefficient (˜10⁵-10⁶ cm⁻¹) of all excimer laser beam having a wavelength in the UV spectrum. Therefore, even for a laser fluence that is lower than a damage threshold, UV lasers easily cause damage to a polyimide surface, such as forming micro bumps and ring features in laser irradiated areas.

### SUMMARY

According to an embodiment of the present invention, there is provided a method of cleaning a polymer surface of debris deposited on the polymer surface as a result of UV laser ablation of the polymer surface. Cleaning is carried out by irradiating the polymer surface using a Nd:YAG laser beam of a predetermined fluence.

There is also provided a method for manufacturing a polymer nozzle member and a nozzle member produced thereby. The manufacturing method includes the above cleaning method. In the manufacturing method, a UV laser beam is used to ablate orifices through a polymer film. The above cleaning method is then used to clean the ablated polymer film.

### BRIEF DESCRIPTION OF DRAWINGS

The invention will be better understood with reference to the drawings, in which:

FIG. 1 is an isometric drawing of an inkjet print cartridge that includes a printhead assembly having a nozzle member in accordance with one embodiment of the present invention;

FIG. 2 is an isometric drawing showing a front surface of a Tape Automated Bonding (TAB) printhead assembly (hereinafter called “TAB head assembly”) removed from the print cartridge of FIG. 1;

FIG. 3 is an isometric drawing showing a back surface of the TAB head assembly of FIG. 2 including a silicon substrate mounted thereon and conductive leads attached to the substrate;

FIG. 4 is an isometric drawing of a partially cut away portion of the TAB head assembly in FIG. 3 showing the relationship of an orifice with respect to a vaporization chamber, a heater resistor, and an edge of the substrate;

FIG. 5 is a side elevation view, in cross section and partially cut-away taken along line D-D of FIG. 4 of the vaporization chamber of FIG. 4;

FIG. 6 is a similar drawing to FIG. 5, showing another embodiment of the nozzle member where a heater element is located on the nozzle member;

FIG. 7 is a similar drawing to FIG. 5, showing yet another embodiment of the nozzle member where ink channels and vaporization chambers are formed in the nozzle member;

FIG. 8 is a flowchart of a sequence of steps for producing the nozzle members of FIGS. 5-7;

FIG. 9 is a drawing illustrating a process that may be used to implement part of the sequence in FIG. 8;

FIGS. 10A and 10B are magnified images of surfaces of a first polyimide film sample and a second polyimide film sample, showing debris on the surfaces after orifices are excimer laser ablated therethrough;

FIGS. 11A and 11B are 50,000 times magnified images of particles of the debris on a portion of the surfaces in FIGS. 10A and 10B; and

FIGS. 12A-14B are images similar to FIGS. 11A and 11B after the surfaces are cleaned by irradiating a single laser pulse, ten laser pulses and a hundred laser pulses respectively of a Q-switched and frequency doubled Nd:YAG laser beam of a fluence of about 150 mJ/cm².

### DETAILED DESCRIPTION

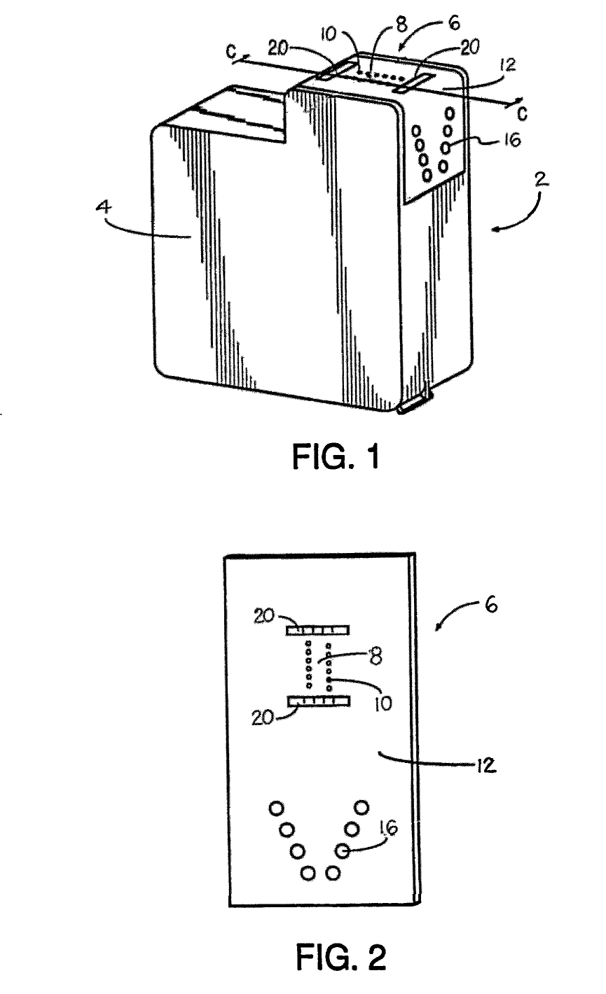

FIG. 1 shows an inkjet print cartridge incorporating a printhead that has a nozzle member according to one embodiment of the present invention. The inkjet print cartridge 2 includes an ink reservoir 4 and a printhead 6. The printhead 6 is formed using Tape Automated Bonding (TAB). The printhead 6 (hereinafter referred to as “TAB head assembly 6”) includes a nozzle member 8 that has two parallel columns of offset holes or orifices 10 formed in a flexible polymer tape 12. The tape 12 may be purchased commercially as Kapton™ tape, available from 3M Corporation, St. Paul, Minn. U.S.A. Other suitable tape may be formed of Upilex™ available from Ube Industries Ltd., Yamaguchi, Japan or its equivalent.

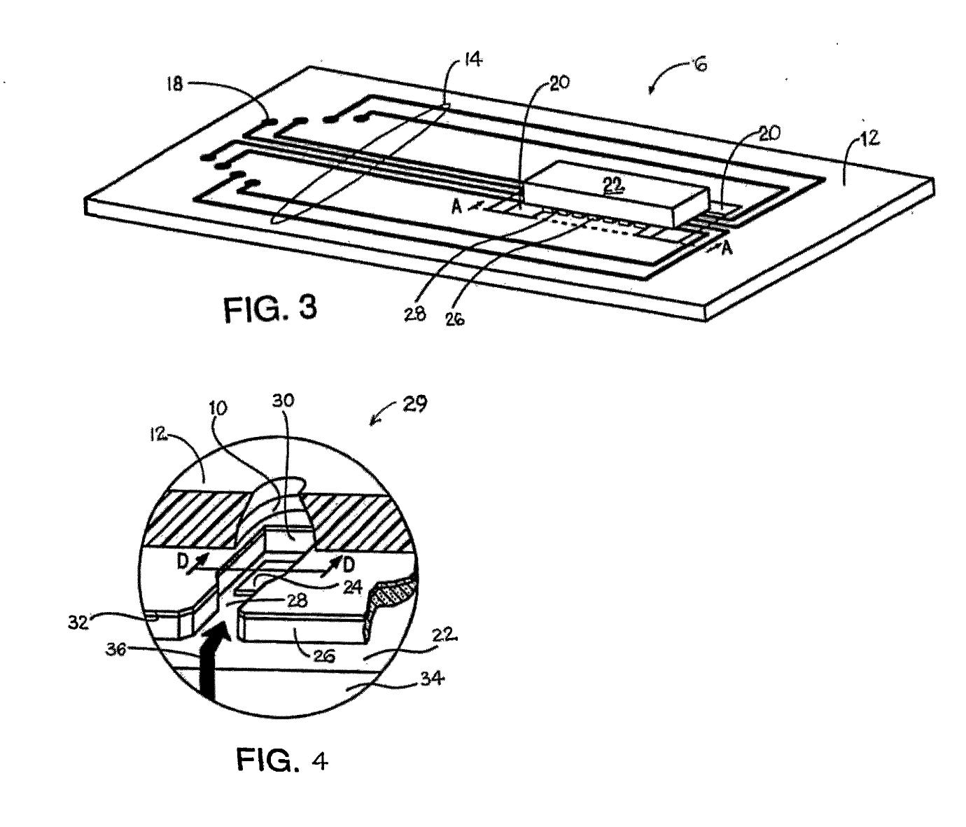

A back surface of the tape 12 includes conductive traces 14 (FIG. 3) formed thereon using a conventional photolithographic etching and/or plating process. These conductive traces 14 are terminated by large contact pads 16 designed to interconnect with a printer. To access these traces 14 from the front surface of the tape 12, holes (vias) 18 must be formed through the front surface of the tape 12 to expose the ends of the traces 14. The exposed ends of the traces 14 are then plated with, for example, gold to form the contact pads 16 shown on the front surface of the tape 12.

Windows 20 extend through the tape 12 and are used to facilitate bonding of the other ends of the conductive traces 14 to electrodes (not shown) on a silicon die or substrate 22 (FIG. 3). The windows 20 are filled with an encapsulant (not shown) to protect any underlying portion of the traces 14 and substrate 22.

FIG. 2 shows a front view of the TAB head assembly 6 removed from the print cartridge 2 and prior to windows 20 in the TAB head assembly 6 being filled with an encapsulant. Affixed to the back of the TAB head assembly 6 is the silicon substrate 22 (FIG. 3) containing a plurality of individually energizable thin film resistors 24 (one of which is shown in FIG. 4). Each resistor 24 is located generally behind a single orifice 10 and acts as an ohmic heater when selectively energized by one or more electrical pulses applied sequentially or simultaneously to one or more of the contact pads 16.

FIG. 3 shows a back surface of the TAB head assembly 6 showing the silicon substrate 22 mounted to the back of the tape 12 and also showing one edge of a barrier layer 26 formed on the substrate 22 defining ink channels and vaporization chambers. Shown along the edge of the barrier layer 26 are the entrances of the ink channels 28 which receive ink from the ink reservoir 4 (FIG. 1).

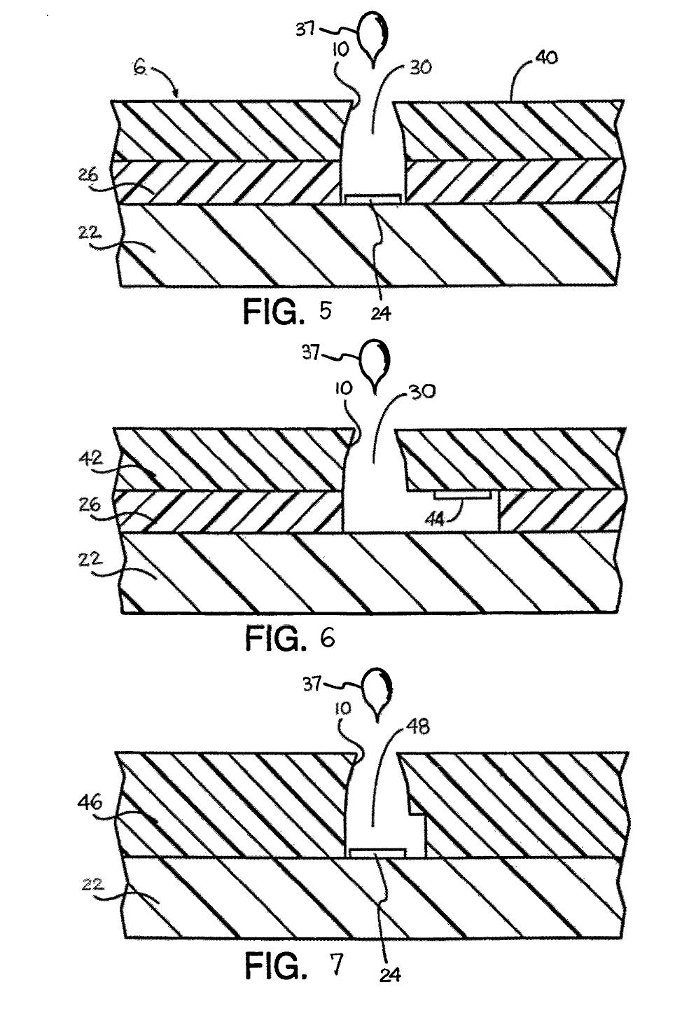

FIG. 4 is an enlarged view of a single ink ejection element 29 that includes a vaporization chamber 30, the thin film resistor 24, and an orifice 10 after the substrate 22 is secured to the back of the tape 12 via a thin adhesive layer 32. A side edge of the substrate 22 is shown as edge 34. In operation, ink flows from the ink reservoir 4, around the side edge 34 of the substrate 22, and into the ink channel 28 and associated vaporization chamber 30, as shown by the arrow 36. Upon energization of the thin film resistor 24, a thin layer of the adjacent ink is superheated, causing explosive vaporization and, consequently, causing a droplet of ink 37 (FIGS. 5-7) to be ejected through the orifice 10. The vaporization chamber 30 is then refilled by capillary action. In a preferred embodiment, the barrier layer 26 is approximately 25 μm thick, the substrate 22 is approximately 500 μm thick, and the tape 12 is formed of a polyimide film that is approximately 50 μm thick.

FIGS. 5-7 show various examples of possible configurations of the TAB head assembly 6. FIG. 5 is a side elevational view in cross-section taken along line C-C in FIG. 1 of one ink ejection element 29 in the TAB head assembly 6 in accordance with one embodiment of the invention. The cross-section shows a laser-ablated polymer nozzle member 40 laminated to a barrier layer 26.

FIG. 6 is a side elevational view in cross-section of an alternative embodiment of an ink ejection element using a polymer, laser-ablated nozzle member 42. A vaporization chamber 30 is bounded by the nozzle member 42, the substrate 22, and the barrier layer 26. In this embodiment, a heater resistor 44 is mounted on the undersurface of the nozzle member 42, not on the substrate 22. Conductive traces (such as shown in FIG. 3) formed on the bottom surface of the nozzle member 42 provide electrical signals to the resistors 44. The various vaporization chambers 30 can also be formed by laser-ablation of a polymer barrier layer 26 in a manner similar to forming the nozzle member 42. In practice, the polymer barrier layer 26 defining the vaporization chambers 30 can be bonded to, be formed adjacent to, or be a unitary part of a nozzle member.

FIG. 7 is a side elevational view in cross-section of a nozzle member 46 having orifices 10, ink channels 28, and vaporization chambers 48 laser-ablated in a same polymer layer 46. Vaporization chambers 48 are formed by laser ablation as a unitary part of the nozzle member 46. If the resistor, such as the resistor 44 in FIG. 6, is formed on the nozzle member 46 itself, the substrate 22 may be eliminated altogether. Multiple lithographic masks may be used to form the orifice 10 and ink path patterns (not shown) in the unitary nozzle member 46.

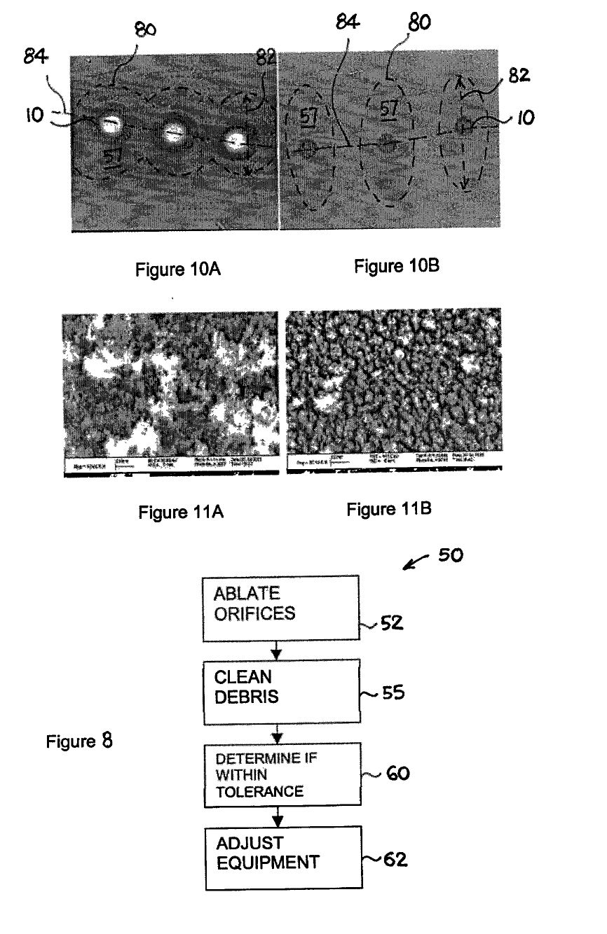

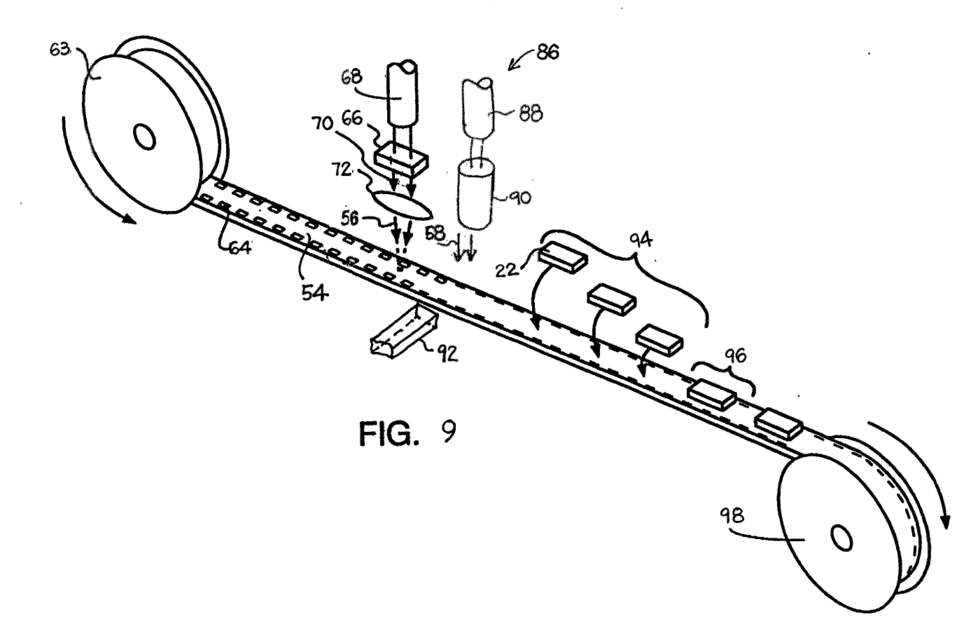

FIG. 8 is a flowchart of a sequence 50 of steps for manufacturing the nozzle members 40, 42 in FIGS. 5 and 6. The sequence 50 starts with an ABLATE ORIFICES step 52, wherein a plurality of orifices 10 is ablated through a polymer film 54 (FIG. 9) using a UV laser beam 56 (FIG. 9). Laser ablating of the polymer film 54 will cause debris 57 (FIGS. 10A-B) to be deposited on a surface of the polymer film 54. The sequence 50 next proceeds to a CLEAN DEBRIS step 55, wherein the debris 57 is cleaned by irradiating the debris-covered polymer surface with an Nd:YAG laser beam 58 of a predetermined fluence. The details of such laser irradiation will be provided later. After cleaning, the sequence 50 proceeds to a ORIFICES WITHIN TOLERANCE? step 60 without having to wait for a substantial period like in the case of plasma ashing. In the step 60, the polymer film 54 is inspected to determine if the orifices 10 are formed to within a predetermined tolerance. If it is determined that any of the orifices 10 are out of tolerance, the sequence 50 proceeds to an ADJUST EQUIPMENT step 62, wherein equipment associated with laser ablation is adjusted to bring subsequent laser ablated orifices 10 to within the predetermined tolerance. If it is determined in the ORIFICES WITHIN TOLERANCE? step 60 that the ablated orifices 10 are within the predetermined tolerance, the sequence 50 is allowed to return to the ABLATE ORIFICES step 52 to continue with laser ablation without making adjustment to the equipment.

FIG. 9 illustrates a representative process that implements part of the sequence 50 in FIG. 8 for forming either the embodiment of the TAB head assembly 6 in FIG. 3 or the TAB head assembly formed using the nozzle member 46 in FIG. 7. The starting material is a Kapton™ or Upilex™ type polymer tape 54, although the tape 54 can be any suitable polymer film that is acceptable for use in the below-described procedure. Some such films may comprise teflon, polyimide, polymethylmethacrylate, polycarbonate, polyester, polyamide, polyethylene-terephthalate or mixtures thereof.

The tape 54 is typically produced in long strips on a reel 63. Sprocket holes 64 along the sides of the tape 54 are used to accurately and securely transport the tape 54. Alternately, the sprocket holes 64 may be omitted and the tape may be transported with other types of fixtures.

In the preferred embodiment, the tape 54 is already provided with conductive copper traces 14, such as shown in FIG. 3, formed thereon using conventional photolithographic and metal deposition processes. The particular pattern of conductive traces 14 depends on the manner in which it is desired to distribute electrical signals to the electrodes formed on the silicon substrate 22, which are subsequently mounted on the tape 54.

In the preferred process, the tape 54 is transported to a laser processing chamber (not shown) and laser-ablated (in the ABLATE ORIFICES step 52) in a pattern defined by one or more masks 66 using laser radiation, such as that generated by an Excimer laser 68 of the F_{2,} ArF, KrCl, KrF, or XeCl type. The masked laser radiation is designated by arrows 70.

In a preferred embodiment, such masks 66 define all of the ablated features for an extended area of the tape 54, for example encompassing multiple orifices 10 in the case of an orifice pattern mask 66, multiple vaporization chambers 48 in the case of a vaporization chamber pattern mask 66, and multiple windows 20 in the case of a window pattern mask 66. Alternatively, patterns such as the orifice pattern, the vaporization chamber pattern, or other patterns may be placed side by side on a common mask substrate (not shown) which is substantially larger than the laser beam. Then such patterns may be moved sequentially into the beam. The masking material used in such masks will preferably be highly reflective at the laser wavelength, of for example, a multi layer dielectric or a metal such as aluminum. The windows 20 can alternatively be formed using conventional photolithographic methods prior to the tape 54 being subjected to the processes shown in FIG. 9.

A laser system for this process generally includes beam delivery optics, beam shaping and homogenizing optics, alignment optics, a high precision and high speed mask positioning system, and a processing chamber including a mechanism for handling and positioning the tape 54. In the preferred embodiment, the laser system uses a projection mask configuration wherein a precision lens 72 interposed between the mask 66 and the tape 54 projects the Excimer laser beam onto the tape 54 in the image of the pattern defined on the mask 66. The masked laser radiation exiting from lens 72 is represented by arrows 56.

Soot is formed and ejected as debris 57 in the ablation process, traveling distances of about one centimeter from the nozzle member 40, 46 being ablated. In the preferred embodiment, the precision lens 72 is more than two centimeters from the nozzle member 40, 46 being ablated, thereby avoiding the buildup of any debris on it or on the mask 66.

After the ABLATE ORIFICE step 52, the polymer tape 54 is stepped, and the process is repeated. This is referred to as a step-and-repeat process. The total processing time required for forming a single pattern on the tape 54 may be in the order of a few seconds. As mentioned above, a single mask pattern may encompass an extended group of ablated features to reduce the processing time per nozzle member 40, 46.

In the ABLATE ORIFICES step 52, short pulses of an intense UV laser beam are absorbed in a thin surface layer of the polymer film 54 within about 1 μm or less of the surface. Preferred laser beam fluences are about 500 μJ/cm² and pulse durations are shorter than 100 ns. Under these conditions, the intense UV laser beam photodissociates the chemical bonds in the polymer film 54 material. Furthermore, the absorbed UV energy is concentrated in such a small volume of material that it rapidly heats the dissociated fragments and ejects them away from the surface of the material. Because these processes occur so quickly, there is little time for heat to propagate to the surrounding material. As a result, the surrounding region is not melted or otherwise damaged, and the perimeter of ablated features can replicate the shape of the incident optical beam 56 with precision on the scale of less than 1 μm.

Although an Excimer laser 68 is used in the preferred embodiments, other ultraviolet light sources with substantially the same optical wavelength and fluence may be used to accomplish the ablation process. Preferably, the wavelength of such an ultraviolet light source will lie in the 150 nm to 400 nm range to allow high absorption in the tape to be ablated.

During laser ablation, high temperature (˜1500-2200° C. ) plasma (not shown) is produced and ejected from the laser-ablated area about 30 to 40 μs following the start of laser ablation. The plasma includes gases such as CO₂, CO and HCN and solid particulate hydrocarbons including C₂-C₁₂. The plasma is sucked away from the laser ablated polyimide surface using a vacuum suction device (not shown). However, some of the gases diffuse into the ambient air and a substantial amount of the particles re-deposit on the polymer surface around the orifice entrance as debris 57 (FIGS. 10A-B).

The particles' distribution on the polymer surface depends on parameters such as ablated orifice dimensions and orifice distributions on the nozzle member 40, 46. FIGS. 10A and 10B show debris distributions on two different polymer film samples, a first and a second sample, respectively under different laser ablation conditions. The first sample is thicker than the second sample. The laser ablated orifices 10 in the first sample have an entrance diameter of about 65 μm while the orifices 10 in the second sample have an entrance diameter of about 20 μm. The fluence of the laser beam 56 used for ablating the first and the second samples are about 500 μJ/cm² and 900 μJ/cm² respectively.

From FIGS. 10A and 10B, it can be seen that the particles are distributed over an oval shaped area 80 around each orifice 10. With less debris, the oval shaped distributions 80 are more pronounced in FIG. 10B. The oval shaped distributions 80 have a longer axis 82 that is substantially orthogonal to an axis 84 formed by the orifices 10. These distributions 80 are the result of simultaneous laser ablation of the orifices 10 using the mask projection configuration described above. Interactions between adjacent plasma plumes from ablating the orifices 10 give rise to the oval shaped distributions 80.

Scanning Electron Microscopy (SEM) inspection reveals that the sizes of the particles in FIG. 10A and 10B are different. FIGS. 11A and 11B are 50,000 times magnified images of the particles adjacent an orifice 10 entrance in FIGS. 10A and 10B respectively where the particle density is highest. Vast majority of the particles is chainlike agglomeration. A large proportion of the particles in FIG. 11A is non-uniformly distributed and has a dimension of about 200 nm. The particles in FIG. 11 B are smaller, having a dimension generally in the range of between 20˜100nm. These smaller particles are also more evenly distributed.

In the CLEAN DEBRIS step 55, the laser ablated portion of the tape 54 is positioned under a cleaning station 86. At the cleaning station 86, debris 57 resulting from the laser ablation is removed. FIG. 9 shows a configuration of the laser cleaning station 86 which includes a laser 88, preferably a flash-lamp pumped, frequency doubled and Q-switched neodymium YAG (Nd:YAG) laser having a wavelength of about 532 nm and a repetition rate of 10 Hz. At such a wavelength the carbon-based debris 57 has a high absorption rate of the laser beam fluence but the tape 54 is partially transparent. A 50 μm tape 54 has a transmissivity of about 50% at the wavelength of about 532 nm. The pulse duration of the laser 88 is set preferably at about 7 ns, which is much shorter than excimer laser pulses (of pulse durations in the range of 30-50 ns) used in other laser cleaning applications. The use of a shorter pulse width laser beam at a higher peak power produces less thermal effect than an equivalent laser beam having a longer pulse width and a lower peak power. The maximum single pulse energy of the laser beam is about 230 mJ.

A beam expander 90 expands the laser beam to cover an appropriate cleaning window. The tape 54 can be mounted on an X-Y stage (not shown) with a vacuum hold-down if it is necessary to accurately position any part of the tape 54 under a smaller sized beam 58. A vacuum suction device 92 is placed adjacent the laser-irradiated area for sucking the particles ejected from the irradiated surface to reduce particle re-deposition. In order to clean different types and thickness of polymer films, the fluence of the laser beam 58 is preferably adjustable by for example changing the magnification factor of the beam expander 90. The number of cleaning pulses is also preferably adjustable from one single pulse to several hundred pulses.

The results of cleaning the two samples using different number of pulses are next discussed. It was found that for a laser 88 having a pulse having a pulse duration of about 7 ns at a wavelength of about 532 nm, the cleaning fluence threshold is about 70 mJ/cm² for the first sample and about 100 mJ/cm² for the second sample. The measured damage threshold for both samples is about 500 mJ/cm².

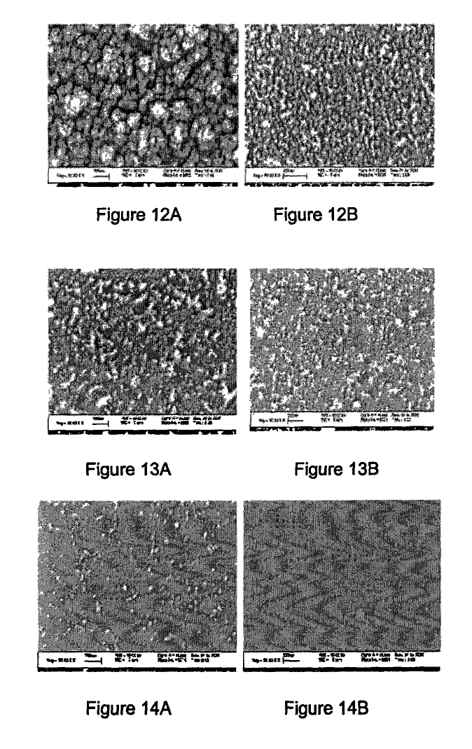

FIGS. 12A-14B show SEM images of the debris covered surfaces in FIGS. 11A and 11B respectively, showing the surface condition at a magnification factor of 50,000 after the surfaces are irradiated with a single pulse, ten pulses, and a hundred pulses of the laser beam 58 at a fluence of preferably about 150 mJ/cm². It should be noted that fluences of between 70-500 mJ/cm² may be used. From the images, it is observed that cleaning with one single pulse irradiation on the ablated surface is able to remove a substantial amount of large fragments of debris on the first sample (FIG. 12A) and larger particles on the second sample (FIG. 12B). With ten pulses, most of the debris 57 was removed from the surfaces of both samples and the polymer films 54 begin to become visible (FIGS. 13A-B). When the samples were irradiated with up to a hundred pulses, it was found that the second sample was cleaned with little or no particles left on the polymer film (FIG. 14B). For the first sample, some particles measuring about 20 nm are still present (FIG. 14A). More pulses may be used to remove the remaining particles on the first sample.

An inspection of one of the irradiated surfaces using Atom Force Microscopy (AFM) showed that the average measured surface roughness is about 3.081 nm. This surface roughness is comparable to the surface roughness (3.04nm) of a polymer film that is not irradiated. Therefore, the laser fluence used for cleaning has little or no impact on the polymer surface.

The chemical composition of the irradiated surfaces is analyzed using X-ray photoelectron spectroscopy (XPS). Table 1 below shows average XPS measurements taken from irradiated and non-irradiated areas of the polymer surface. For comparison, Table 1 also includes corresponding measurements taken from a plasma-ashed polymer sample. The measurements taken from the plasma-ashed polymer sample is taken from areas adjacent laser ablated orifices and areas that are about 5 mm away from the orifices.

TABLE 1
XPS measurements of laser-cleaned and plasma-ashed polymer

| | | Carbon | Nitrogen | Oxygen | Ratio | Ratio |
|---|---|---|---|---|---|---|
| Type of | Measured | Concen- | Concen- | Concen- | of | of |
| Cleaning | Areas | tration (C) | tration (N) | tration (O) | O/C | O/N |
| Laser | Non- | 75.5 | 6.8 | 17.8 | 0.24 | 0.09 |
| | irradiated | | | | | |
| | areas | | | | | |
| | Irradiated | 85.8 | 2.5 | 11.8 | 0.14 | 0.03 |
| | areas | | | | | |
| Plasma- | Areas | 62.2 | 9.6 | 28.2 | 0.45 | 0.15 |
| ashed | about | | | | | |
| | 5 mm | | | | | |
| | away | | | | | |
| | from | | | | | |
| | orifices | | | | | |
| | Areas | 69.0 | 6.0 | 25.0 | 0.36 | 0.09 |
| | adjacent | | | | | |
| | orifices | | | | | |

### Surfaces

From the table, it can be seen that the O/C and O/N ratios for laser irradiated areas are lower than those of the non-irradiated areas. These O/C and O/N ratios associated with a laser cleaned polymer surface are comparatively lower than those of a plasma ashed polymer surface.

After cleaning, the tape 54 is stepped to an optical alignment station 94 (FIG. 9) incorporated in a conventional automatic TAB bonder (not shown), such as an inner lead bonder commercially available from Shinkawa Corporation, Tokyo, Japan, to align a substrate 22 to the orifices 10. The automatic alignment of the nozzle member 8 with the substrate 22 not only precisely aligns the orifices 10 with the resistors 24 but also inherently aligns the electrodes on the substrate 22 with the ends of the conductive traces 14 formed in the tape 54.

The automatic TAB bonder then uses a gang bonding method to press the ends of the conductive traces 14 down onto the associated substrate electrodes through the windows 20 formed in the tape 54. The bonder then applies heat, such as by using thermocompression bonding, to weld the ends of the traces 14 to the associated electrodes. Other types of bonding can also be used, such as ultrasonic bonding, conductive epoxy, solder paste, or other well-known means.

The tape 54 is then stepped to a heat and pressure station 96 (FIG. 9). An adhesive layer 32 (FIG. 4) exists on the top surface of the barrier layer 26 formed on the silicon substrate 22. After the above-described bonding step, the silicon substrates 22 are then pressed down against the tape 54, and heat is applied to cure the adhesive layer 32 and physically bond the substrates 22 to the tape 54.

Thereafter the tape 54 steps and is optionally taken up on the take-up reel 98. The tape 54 may then later be cut to separate the individual TAB head assemblies 6 from one another. The resulting TAB head assembly 6 is then positioned on the print cartridge 2. An adhesive seal (not shown) is formed to firmly secure the TAB head assembly 6 to the print cartridge 2 and to encapsulate the traces 14 extending from the substrate 22 so as to isolate the traces 14 from the ink.

Advantageously, the above-described method of laser cleaning of debris from a UV laser ablated polymer surface requires a shorter cleaning time than that required using conventional plasma ashing without any loss of effectiveness in cleaning. Cleaning of one nozzle member takes only a few seconds depending on the size of particles and density of debris to be removed. This time is much shorter compared to plasma ashing which requires cleaning times of a few minutes. Laser cleaning also has less thermal effect on the polymer surface and therefore has less effect on nozzle member parameters such as overall orifice pattern size and orifice alignment. Unlike plasma ashing, only contaminated areas around the orifices are irradiated with the laser beam.

It should be understood that the range of laser beam fluences and number of laser pulses available for useful surface cleaning will vary with respect to the surface to be cleaned. It is not intended that the invention be limited by the range of laser beam fluences and number of laser pulses identified herein. Effective cleaning can be accomplished by a single laser pulse per exposure area. Enhanced cleaning may also be obtained using two or more laser pulses per exposure area. Two or more laser pulses per exposure area may also be required to obtain useful cleaning if the subject material is heavily contaminated or because lower than normal laser beam fluences are required to avoid surface damage. It is well within the skill of those practicing this art to determine an appropriate laser beam fluence and number of pulses per exposure area to obtain useful, damage-free cleaning.

We claim:

1. A method of cleaning a polymer surface comprising:
ablating the polymer surface using a UV laser beam; and
cleaning debris deposited on the polymer surface as a result of the laser ablation by irradiating the polymer surface using a Nd:YAG laser beam of a predetermined fluence.

2. A method according to claim 1, wherein irradiating the polymer surface includes irradiating the polymer surface using a frequency doubled Nd:YAG laser beam of a predetermined fluence.

3. A method according to claim 2, wherein irradiating the polymer surface includes irradiating the polymer surface using a predetermined number of pulses of a Q-switched and frequency doubled Nd:YAG laser beam of a predetermined fluence.

4. A method according to claim 3, wherein irradiating the polymer surface includes irradiating the polymer surface using a Q-switched and frequency doubled Nd:YAG laser beam; wherein at least one of the number of pulses or the fluence of the laser beam is adjustable in accordance with a size of particles and density of the debris.

5. A method according to claim 4, wherein irradiating the polymer surface includes irradiating the polymer surface using a Q-switched and frequency doubled Nd:YAG laser beam having a repetition frequency of about 10 Hz, a pulse duration of about 7 ns and a fluence of about 150 mJ/cm²; wherein the number of pulses is adjustable in accordance with a size of particles and density of the debris.

6. A method according to claim 1, wherein the polymer surface includes a polyimide surface.

7. A method of manufacturing a polymer nozzle member of an inkjet printhead, the method comprising:
ablating a plurality of orifices through a polymer film using a UV laser beam; and
cleaning debris deposited on a surface of the polymer film as a result of the laser ablation by irradiating the polymer surface with an Nd:YAG laser beam of a predetermined fluence.

8. A method according to claim 7, further including:
determining if the orifices are formed to within a predetermined tolerance after cleaning without having to wait a substantial period; and
calibrating equipment associated with ablation of the plurality of orifices so that orifices would be ablated to within the predetermined tolerance.

9. A method according to claim 7, wherein cleaning the polymer surface includes irradiating the polymer surface using a frequency doubled Nd:YAG laser beam of a predetermined fluence.

10. A method according to claim 9, wherein irradiating the polymer surface includes irradiating the polymer surface using a predetermined number of pulses of a Q-switched and frequency doubled Nd:YAG laser beam of a predetermined fluence.

11. A method according to claim 10, wherein irradiating the polymer surface includes irradiating the polymer surface using a Q-switched and frequency doubled Nd:YAG laser beam; wherein at least one of the number of pulses or the fluence of the laser beam is adjustable in accordance with a size of particles and density of the debris.

12. A method according to claim 7, wherein the polymer nozzle member includes a polyimide nozzle member.

13. A nozzle member suitable for use with an inkjet printhead comprising:
a polymer film having a plurality of orifices ablated therethrough using a UV laser beam; wherein debris deposited on a surface of the polymer film as a result of the laser ablation is cleaned by irradiating the polymer surface with an Nd:YAG laser beam of a predetermined fluence.

14. A nozzle member according to claim 13, wherein irradiating the polymer surface includes irradiating the polymer surface using a frequency doubled ND:YAG laser beam of a predetermined fluence.

15. A nozzle member according to claim 14, wherein irradiating the polymer surface includes irradiating the polymer surface using a predetermined number of pulses of a Q-switched and frequency doubled Nd:YAG laser beam of a predetermined fluence.

16. A nozzle member according to claim 15, wherein irradiating the polymer surface includes irradiating the polymer surface using a Q-switched and frequency doubled Nd:YAG laser beam; wherein at least one of the number of pulses or the fluence of the laser beam is adjustable in accordance with a size of particles and density of the debris.

17. A nozzle member according to claim 13, wherein the polymer film includes a polyimide film.
